(19) United States
(12) Patent Application Publication
(10) Pub. No.: US 2019/0362150 A1
(43) Pub. Date: Nov. 28, 2019

(54) IMAGE PROCESSING SYSTEM AND IMAGE PROCESSING METHOD

(71) Applicants: LITE-ON ELECTRONICS (GUANGZHOU) LIMITED, Guangzhou (CN); LITE-ON TECHNOLOGY CORPORATION, Taipei (TW)

(72) Inventors: Shou-Te WEI, Taipei (TW); Wei-Chih CHEN, Taipei (TW)

(21) Appl. No.: 16/100,290

(22) Filed: Aug. 10, 2018

(30) Foreign Application Priority Data
May 25, 2018 (CN) 201810517209.3

(51) Int. Cl. G06K 9/00; G06T 15/06; G06T 19/00; G06T 7/70

(52) U.S. Cl. CPC G06K 9/00671; G06T 7/70; G06T 19/006; G06T 15/06

(57) ABSTRACT

An image processing system includes a camera, a positioning device, a posture estimation device, and a processor. The camera captures a real environment. The positioning device detects a camera position of the camera. The posture estimation device detects a camera posture of the camera. The processor estimates light source information according to time information and latitude information. And, the processor makes a reflected image of the real environment be appeared on a first virtual object according to the camera position, the camera posture, real environment information corresponding to the real environment, the light source information, first virtual information of the first virtual object, and a ray tracing algorithm.

This application claims the benefit of People's Republic of China application Serial No. 201810517209.3, filed May 25, 2018, the subject matter of which is incorporated herein by reference.

### BACKGROUND OF THE INVENTION

### Field of the Invention

The disclosure relates in general to an image processing system and the image processing method, and more particularly to an image processing system and an image processing method used in augmented reality.

### Description of the Related Art

Generally speaking, in the augmented reality technology, it may easily occur that the virtual object does not merge with the real environment or the virtual object is not real enough. Such defect normally occurs when the situations of the real environment are not considered during rendering of the virtual object. For example, when a user is viewing a scene of the augmented reality, light on the virtual object and the shadow of the virtual object are not adjusted according to the orientation or angle of the camera.

Therefore, it has become a prominent task for the industries to make the virtual object in the augmented reality be more closed to the real environment.

### SUMMARY OF THE INVENTION

According to one embodiment of the present disclosure, an image processing system is provided. The image processing system includes a camera, a positioning device, a posture estimation device, and a processor. The camera captures a real environment. The positioning device detects a camera position of the camera. The posture estimation device detects a camera posture of the camera. The processor estimates light source information according to time information and latitude information. And, the processor makes a reflected image of the real environment be appeared on a first virtual object according to the camera position, the camera posture, real environment information corresponding to the real environment, the light source information, first virtual information of the first virtual object, and a ray tracing algorithm.

According to another embodiment of the present disclosure, an image processing method is provided. The image processing method includes following steps: capturing a real environment by a camera; detecting a camera position of the camera by a positioning device; detecting a camera posture of the camera by a posture estimation device; estimating light source information by a processor according to time information and latitude information; and appearing a reflected image of the real environment on the first virtual object by the processor according to the camera position, the camera posture, a real environment information corresponding to the real environment, the light source information, first virtual information of the first virtual object, and a ray tracing algorithm.

To summarize, the image processing system and the image processing method of the disclosure utilize the camera position, the camera posture, the real environment information, the light source information, the virtual information of the virtual object, and the ray tracing algorithm to consider the position of the sun in the world coordinate system, the light source color temperature, the placement position and the orientation of the camera, the material and/or reflectivity of the real object, the material and/or the reflectivity of the virtual object and the ray tracing algorithm, such that the reflected image of the real environment is appeared on the virtual object and the virtual object can be appeared as being more closed to the appearance with the light and shade of the real environment.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1A a block diagram of an image processing system according to an embodiment of the disclosure;

FIG. 1B a block diagram of an image processing system according to another embodiment of the disclosure;

FIG. 2 is a flowchart of an image processing method according to an embodiment of the disclosure;

FIG. 3 is a schematic diagram of an application of the image processing method according to an embodiment of the disclosure;

FIG. 4 is a schematic diagram of an application of the image processing method according to an embodiment of the disclosure;

FIG. 5 is a schematic diagram of an application of the image processing method according to an embodiment of the disclosure; and

FIG. 6 is a schematic diagram of an application of the image processing method according to an embodiment of the disclosure.

### DETAILED DESCRIPTION OF THE DISCLOSURE

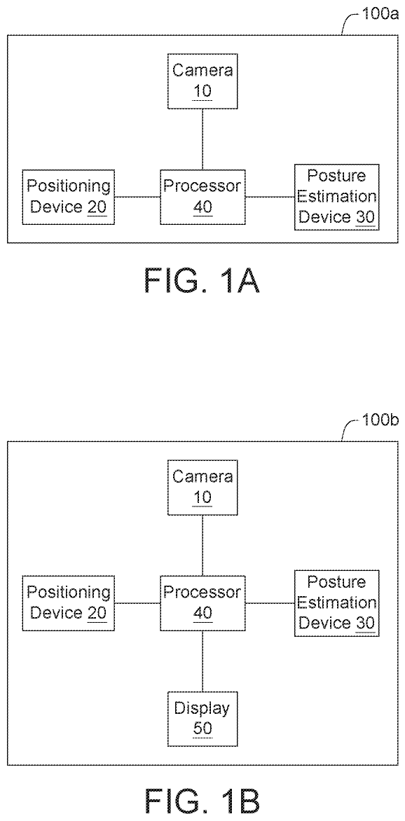

Referring to FIG. 1A, a block diagram of an image processing system 100a according to an embodiment of the disclosure is shown. In an embodiment, the image processing system 100a includes a camera 10, a positioning device 20, a posture estimation device 30, and a processor 40. In an embodiment, the processor 40 is respectively coupled to the camera 10, the positioning device 20, and the posture estimation device 30.

In an embodiment, the camera 10 can be implemented by a charge coupled device (CCD) or a complementary metal-oxide semiconductor (CMOS). The positioning device 20 can be implemented by a global positioning system (GPS) locator which captures position information of the camera 10. The posture estimation device 30 can be implemented by an inertial measurement unit (IMU) which detects an orientation of the camera 10 (such as facing north or south, or an elevation angle or a depression angle of the camera). The processor 40 can be implemented by a microcontroller, a microprocessor, a digital signal processor, application specific integrated circuit (ASIC) or a logic circuit.

Referring to FIG. 1B, a block diagram of an image processing system 100b according to another embodiment of the disclosure is shown. In comparison to the image processing system 100a of FIG. 1A, the image processing system 100b of FIG. 1B further includes a display 50 to which the processor 40 is coupled. The display 50 can be implemented by a display device of a hand-held electronic device (such as a mobile phone or a PC tablet) or a display device of a head mounted device. In an embodiment, the camera 10, the positioning device 20, the posture estimation device 30, the processor 40, and the display 50 can be integrated into one device (such as the hand-held electronic device).

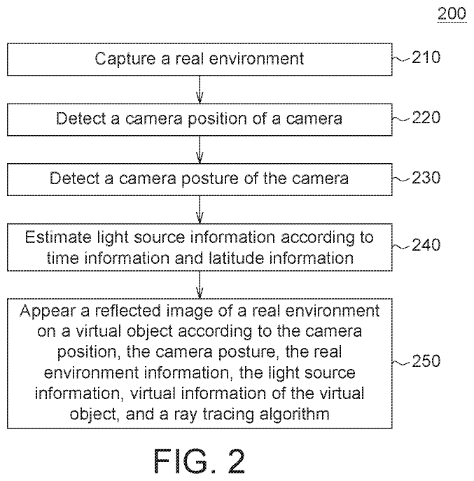

Referring to FIG. 2, a flowchart of an image processing method 200 according to an embodiment of the disclosure is shown. Detailed descriptions of the process of the image processing method 200 of the disclosure are disclosed below. The components mentioned in the image processing method 200 can be implemented by the components disclosed in FIG. 1A or FIG. 1B.

In step 210, a real environment is captured by the camera 10.

In an embodiment, real environment information corresponding to the real environment, which includes three-dimensional information, a reflectivity, a color or material information of each real object in the real environment, is obtained from a precision map. For example, when the camera 10 captures an office scene, the processor 40 can obtain respective three-dimensional information, reflectivity, color or material information of each real object such as desk, chair, and window in the office scene according to a precision map corresponding to the office scene.

In an embodiment, the material information and reflectivity of the real environment information can be used as a reference for ray tracing during the rendering process to confirm the direction of the light in the real environment and/or on the virtual object.

In step 220, a camera position of the camera 10 is detected by the positioning device 20.

In an embodiment, the positioning device 20 is a GPS locator, which captures the camera position of the camera 10 (such as GPS information of the camera 10).

In step 230, a camera posture of the camera 10 is detected by the posture estimation device 30.

In an embodiment, the posture estimation device 30 is an inertial measurement unit, which detects an orientation of the camera 10 (such as facing north or south, or an elevation angle or a depression angle) to obtain the camera posture of the camera 10.

The order of steps 210 to 230 can be adjusted according to actual implementation.

In step 240, light source information is estimated by the processor 40 according to time information (such as the current time and date) and latitude information (such as the latitude of the camera 10). In an embodiment, the time information and the latitude information can be obtained by the positioning device 20 or obtained from the Internet.

In an embodiment, when the processor 40 obtains the time information and the latitude information by the positioning device 20 or from the Internet, the processor 40 can obtain the light source information by way of estimation or table lookup. The light source information includes a light source position (such as the position of the sun in the world coordinate system) or color temperature information (such as the light source color).

In an embodiment, the processor 40 can create a table of weather conditions and their corresponding color temperature information. For example, the table records the weather conditions of different time sessions, such as sunny morning, sunny evening, cloudy morning and cloudy evening, and the color temperatures corresponding to the said time sessions. Thus, when the processor 40 obtains time information and latitude information, the processor 40 can firstly obtain the weather of the location and then obtain the color temperature information by way of table lookup.

In step 250, a reflected image of the real environment is appeared on the virtual object by the processor 40 according to the camera position, the camera posture, the real environment information, the light source information, virtual information of the virtual object, and a ray tracing algorithm.

In an embodiment, the processor 40 can obtain the camera position, the camera posture, the real environment information, the light source information, and the virtual information of the virtual object from steps 210 to 240. In step 250, the reflected image of real environment can be appeared on the virtual object by the processor 40 according to the information and the ray tracing algorithm. In an embodiment, since the precision map includes the color of the real object, the reflected image of the real object with color can be appeared on the virtual object by the processor 40, such that the virtual object can be appeared as being more closed to the appearance with the light and shade of the real environment.

Detailed descriptions of the application of the ray tracing algorithm are disclosed below.

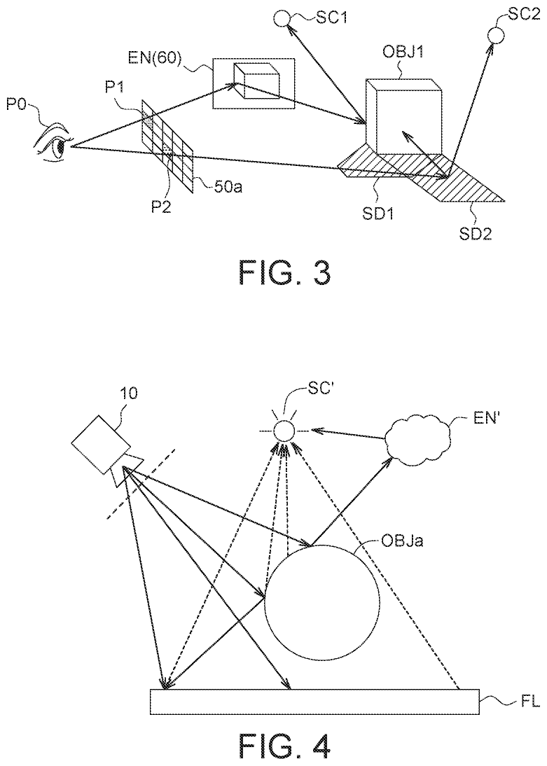

Referring to FIG. 3, a schematic diagram of an application of the ray tracing algorithm according to an embodiment of the disclosure is shown. In an embodiment, virtual information of a virtual object OBJ1 is predetermined information, which includes a virtual position of the virtual object OBJ1 and a reflectivity of the virtual object OBJ1.

As shown in FIG. 3, the processor 40 estimates the brightness and color which should be displayed in each pixel (for example, positions P1 and P2) of the display 50a by using the ray tracing algorithm. In the present example, a human eye position P0 can be replaced by a position of the camera 10. The ray tracing algorithm calculates the reflection, refraction and/or shadow effect of a light hitting the real environment EN and the virtual object OBJ1, wherein the light is emitted from each pixel position (such as position P1, P2) of the display 50a and viewed from a human eye position P0. Based on the reflection path and refraction path of the light in the space, each pixel of the display 50a corresponds to light information.

For example, the processor 40 simulates the following situations. After a light is emitted from the position P1 and hits the real environment EN (such as a mirror 60), a reflected light is generated from the real environment EN. Then, the reflected light hits the virtual object OBJ1 to generate another reflected light from the virtual object OBJ1. Then, the other reflected light hits the light source SC1. Then, the processor 40 estimates the brightness and color temperature which should be displayed at the position P1.

For example, the processor 40 simulates the following situations. After a light is emitted from the position P2 and hits a ground shadow SD2 of the virtual object OBJ1, a reflected light is generated from the ground shadow SD2. Then, the reflected light hits the virtual object OBJ1 and the light source SC2. Thus, the processor 40 estimates the brightness and color temperature which should be displayed at the position P2.

The space illustrated in FIG. 3 includes the reflection, refraction, scattering or shadow (such as shadows SD1 and SD2) of multiple light sources. However, for the convenience of explanation, only some of the lights related to the above example are illustrated.

Then, the example in which the processor 40 reflects the reflected image of the real environment on the virtual object according to the camera position, the camera posture, the real environment information, the light source information, the virtual information of the virtual object and the ray tracing algorithm and the example in which the processor 40 reflects the virtual object on another virtual object are disclosed.

Referring to FIGS. 4 to 6, schematic diagrams of an application of an image processing method according to an embodiment of the disclosure are respectively shown. It should be noted that the arrow direction of FIG. 4 is the calculation direction of the ray tracing algorithm and is opposite to the actual irradiation direction of the light source SC′. As indicated in FIG. 4, the virtual object OBJa is a virtual smooth metal ball suspended above the floor FL. After a light is emitted from the light source SC′ and hits the real environment EN′ and the virtual object OBJa, the real environment EN′ reflects the light to the virtual object OBJa such that the reflected image of the real environment EN′ is reflected on the virtual object OBJa. Then, the light on the virtual object OBJa is reflected to the camera 10. Based on the above description and the application of the ray tracing algorithm, the processor 40 obtains the effect produced on the virtual object OBJa by the light source SC′ and the real environment EN′ according to the camera position (such as the placement position of the camera 10), the camera posture (such as the orientation of the camera 10), the real environment information of the real environment EN′, the light source information of the light source SC′, and the virtual information of the virtual object OBJa. Then, the reflected image of the real environment EN′ is appeared on the virtual object OBJa by the processor 40 according to the obtained effect.

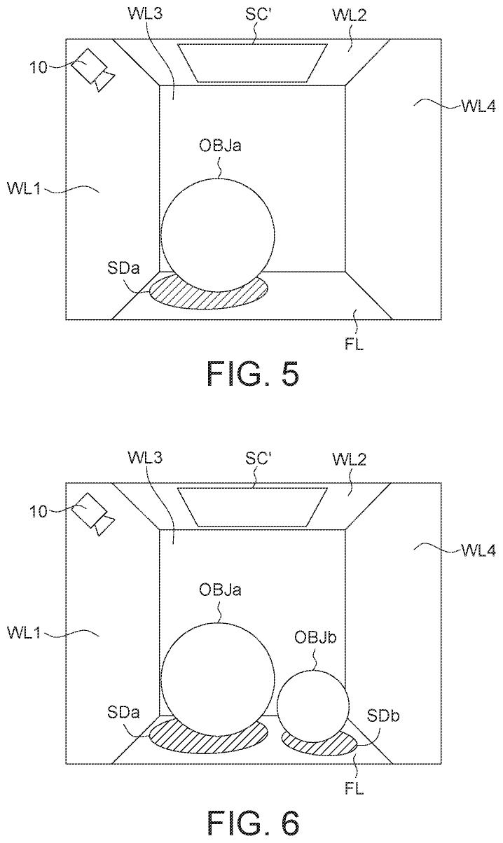

The principles of FIG. 5 are similar to that of FIG. 4. In the present example, the virtual object OBJa is a virtual smooth metal ball suspended above the floor FL. After a light is emitted from the light source SC′ and hits the walls WL1 to WL4 (that is, the real environment) and the virtual object OBJa, the walls WL1 to WL4 reflect the light to the virtual object OBJa. Then, the light on the virtual object OBJa is reflected to the camera 10. Based on the above description and the application of the ray tracing algorithm, the processor 40 obtains the effect produced on the virtual object OBJa by the light source SC′ and the walls WL1 to WL4 according to the camera position (such as the placement position of the camera 10), the camera posture (such as the orientation of the camera 10), the real environment information of the real environment (such as the walls WL1 to WL4), the light source information of the light source SC′ and the virtual information of the virtual object OBJa. Then, the reflected images of the walls WL1 to WL4 are appeared on the virtual object OBJa by the processor 40 and the virtual shadow SDa of the virtual object OBJa is presented according to the obtained effect by the processor 40.

In an embodiment, when a reflected image of a real environment (such as the walls WL1 to WL4) is appeared on a virtual object (such as the virtual object OBJa), the virtual object is referred as a rendering object. The display 50 of FIG. 1B simultaneously displays the real environment and the rendering object.

The principles of FIG. 6 are similar to that of FIG. 5. In the present example, both the virtual objects OBJa and OBJb are a virtual smooth metal ball suspended above the floor FL. After a light is emitted from the light source SC′ and hits the walls WL1 to WL4 (the real environment) and the virtual objects OBJa and OBJb, the walls WL1 to WL4 reflect the light to the virtual objects OBJa and OBJb. In an embodiment, the lights reflected to one of the virtual object OBJa and OBJb can be reflected to the other one of the virtual object OBJa and OBJb, such that the reflected image of the virtual object OBJb can be appeared on the virtual object OBJa by the processor 40 or the reflected image of the virtual object OBJa can be appeared on the virtual object OBJb by the processor 40.

In other words, in terms of the virtual object OBJa, the processor 40 obtains the effect produced on the virtual object OBJa by the light source SC′, the walls WL1 to WL4, and the virtual object OBJb according to the camera position (such as the placement position of the camera 10), the camera posture (such as the orientation of the camera 10), the real environment information of the real environment (such as the walls WL1 to WL4), the light source information of the light source SC′ and respective virtual information of the virtual objects OBJa and OBJb and the ray tracing algorithm. Then, the reflected images of the walls WL1 to WL4 and the virtual object OBJb are appeared on the virtual object OBJa by the processor 40, and the virtual shadow SDa of the virtual object OBJa is presented according to the obtained effect by the processor 40.

On the other hand, in terms of the virtual object OBJb, the processor 40 obtains the effect produced on the virtual object OBJb by the light source SC′, the walls WL1 to WL4 and the virtual object OBJa according to the camera position (such as the placement position of the camera 10), the camera posture (such as the orientation of the camera 10), the real environment information of the real environment (such as the walls WL1 to WL4), the light source information of the light source SC′ and respective virtual information of the virtual objects OBJa and OBJb and the ray tracing algorithm. Then, the reflected images of the walls WL1 to WL4 and the virtual object OBJa are appeared on the virtual object OBJb by the processor 40 and the virtual shadow SDb of the virtual object OBJb is presented according to the obtained effect by the processor 40.

In an embodiment, when the reflected image of a real environment (such as the walls WL1 to WL4) is appeared on a virtual object (such as the virtual object OBJa), the virtual object is referred as a rendering object. When the reflected image of the virtual object is also appeared on the other virtual object (such as the virtual object OBJb), the other virtual object is also referred as a rendering object. The display 50 of FIG. 1B simultaneously displays the real environment and the rendering objects, such that the virtual objects can be appeared as being more closed to the appearance with the light and shade of the real environment.

To summarize, the image processing system and the image processing method of the disclosure utilize the camera position, the camera posture, the real environment information, the light source information, the virtual information of the virtual object and the ray tracing algorithm to consider the position of the sun in the world coordinate system, the light source color temperature, the placement position and/orientation of the camera, the material and/or reflectivity of the real object, the material and/or reflectivity of the virtual object and the ray tracing algorithm, such that a reflected image of the real environment is appeared on the virtual object and the virtual object can be appeared as being more closed to the appearance with the light and shade of the real environment.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An image processing system, comprising:
a camera for capturing a real environment;
a positioning device for detecting a camera position of the camera;
a posture estimation device for detecting a camera posture of the camera; and
a processor for estimating light source information according to time information and latitude information and making a reflected image of the real environment be appeared on a first virtual object according to the camera position, the camera posture, real environment information corresponding to the real environment, the light source information, a first virtual information of the first virtual object and a ray tracing algorithm.

2. The image processing system according to claim 1, wherein the real environment information is obtained from a precision map, and the real environment information comprises three-dimensional information, a reflectivity, a color or material information of each real object in the real environment.

3. The image processing system according to claim 1, wherein the light source information comprises a light source position or color temperature information.

4. The image processing system according to claim 1, wherein the first virtual information comprises a virtual position of the first virtual object and a reflectivity of the first virtual object.

5. The image processing system according to claim 1, wherein the first virtual object becomes a first rendering object when the reflected image of the real environment is appeared on the first virtual object, and the image processing system further comprises:
a display for simultaneously displaying the real environment and the first rendering object.

6. The image processing system according to claim 1, wherein the processor further makes a reflected image of the first virtual object be appeared on a second virtual object according to the camera position, the camera posture, the light source information, the first virtual information of the first virtual object, second virtual information of the second virtual object, and the ray tracing algorithm, and the second virtual information comprises a virtual position of the second virtual object and a reflectivity of the second virtual object.

7. The image processing system according to claim 6, wherein the first virtual object is referred as a first rendering object when the reflected image of the real environment is appeared on the first virtual object, and the second virtual object is referred as a second rendering object when the reflected image of the first virtual object is appeared on the second virtual object, and the image processing system further comprises:
a display for simultaneously displaying the real environment, the first rendering object, and the second rendering object.

8. An image processing method, comprising:
capturing a real environment by a camera;
detecting a camera position of the camera by a positioning device;
detecting a camera posture of the camera by a posture estimation device;
estimating light source information by a processor according to time information and latitude information; and
appearing a reflected image of the real environment on a first virtual object by the processor according to the camera position, the camera posture, real environment information corresponding to the real environment, the light source information, first virtual information of the first virtual object, and a ray tracing algorithm.

9. The image processing method according to claim 8, wherein the real environment information is obtained from a precision map, and the real environment information comprises three-dimensional information, a reflectivity, a color or material information of each real object in the real environment.

10. The image processing method according to claim 8, wherein the light source information comprises a light source position or color temperature information.

11. The image processing method according to claim 8, wherein the first virtual information comprises a virtual position of the first virtual object and a reflectivity of the first virtual object.

12. The image processing method according to claim 8, wherein the first virtual object is referred as a first rendering object when the reflected image of the real environment information is appeared on the first virtual object, and the image processing method further comprises:
simultaneously displaying the real environment and the first rendering object by a display.

13. The image processing method according to claim 8, further comprising:
appearing a reflected image of the first virtual object on a second virtual object by the processor according to the camera position, the camera posture, the light source information, the first virtual information of the first virtual object, second virtual information of the second virtual object, and the ray tracing algorithm, wherein the second virtual information comprises a virtual position of the second virtual object and a reflectivity of the second virtual object.

14. The image processing method according to claim 13, wherein the first virtual object is referred as a first rendering object when the reflected image of the real environment is appeared on the first virtual object, and the second virtual object is referred as a second rendering object when the reflected image of the first virtual object is appeared on the second virtual object, and the image processing method further comprises:
simultaneously displaying the real environment, the first rendering object, and the second rendering object by a display.
